(19) United States
(12) Patent Application Publication
(10) Pub. No.: US 2011/0305177 A1
(43) Pub. Date: Dec. 15, 2011

(54) FIXED MOBILE CONVERGENCE APPARATUS AND METHOD FOR SEARCHING ACCESS POINT

(75) Inventors: Hyun Bae WOO, Seoul (KR); Young Chan KIM, Seoul (KR); Hee Keun SONG, Anyang-si (KR); Kyung Bang LEE, Seoul (KR); Young Jae HEO, Goyang-si (KR)

(73) Assignee: Pantech Co., Ltd., Seoul (KR)

(21) Appl. No.: 13/030,029

(22) Filed: Feb. 17, 2011

(30) Foreign Application Priority Data
Jun. 10, 2010 (KR) 10-2010-0054779

(51) Int. Cl. H04W 52/02

(52) U.S. Cl. 370/311

(57) ABSTRACT

Disclosed herein are a fixed mobile convergence (FMC) apparatus and a method for searching an access point. The FMC apparatus and method effectively search an access point using a frequency searching method of a radio access technology (RAT) service in which a discontinuous reception (DRX) operation is used to increase efficiency in power consumption of the FMC apparatus. The FMC apparatus recognizes an area available for a wireless local area network (WLAN) service and may automatically search an access point in the corresponding area so that it is possible to decrease inconvenience to a user.

### CROSS-REFERENCE TO RELATED APPLICATION

This application claims priority from and the benefit under 35 U.S.C. §119(a) of Korean Patent Application No. 10-2010-0054779, filed on Jun. 10, 2010, which is hereby incorporated by reference for all purposes as if fully set forth herein.

### BACKGROUND

1. Field

The following description relates to a fixed mobile convergence (FMC) apparatus and a method for searching an access point.

2. Discussion of the Background

Communication environments are being developed so that wired and wireless is communications are integrated. As an example, there has been proposed a fixed mobile convergence (FMC) technology for integrating radio access technology (RAT), such as WCDMA, GSM, and/or LTE and a wireless local area network (WLAN). The FMC technology integrates different networks and supports mobility between the networks.

In the environment in which a next-generation mobile communication network, an existing mobile communication network, and a wired data network are mixed together, users can receive consistent and continuous services using the FMC technology regardless of the differences of the networks.

The representative type of an FMC apparatus is a dual mode mobile communication terminal implemented by adding a WLAN function to an existing mobile communication terminal. The bandwidth of data service through the WLAN is increased by a few times to a few tens of times as compared with a 3G mobile communication network, such as WCDMA or HSDPA. Therefore, the data service through the WLAN has various application fields as compared with the mobile communication network.

Access points for receiving WLAN services may provide a cheap equipment price and high-speed data transmission. Thus, WLAN services may be used by easily installing access points in an area in which a wired LAN is provided. The WLAN services are provided between the FMC to mobile communication terminals with a built-in RAT service, such as WCDMA or GSM, due to cheap price and simple installation.

Therefore, the FMC apparatus searches WLAN signals in addition to a frequency search for the RAT services. The additional search of the WLAN signals is a very serious issue in mobile communication terminals having restricted power. However, since access points for the WLAN services are not installed all over the nation like base stations for the RAT services, is continuous search of access points for the WLAN services has influence on power consumption of terminals, and therefore, the power consumption is increased.

### SUMMARY

Exemplary embodiments of the present invention provide a fixed mobile convergence (FMC) apparatus and a method for searching an access point, in which an access point is effectively searched using a frequency searching method of a radio access technology (RAT) service, and power consumption for a wireless local area network (WLAN) service is efficiently handled.

Exemplary embodiments of the present invention provide an FMC apparatus and a method for searching an access point, in which the FMC apparatus recognizes an area available for the WLAN service and automatically searches an access point in the corresponding area so that it is possible to provide convenience in which a user uses the services the presence of the service.

Additional features of the invention will be set forth in the description which follows, and in part will be apparent from the description, or may be learned by practice of the invention.

An exemplary embodiment provides an FMC apparatus including: a control unit to periodically alternate between a sleep mode and a wake mode to perform a discontinuous reception (DRX) operation; a wireless connection executing unit to monitor radio access technology (RAT) channels in the wake mode; and a wireless local area network (WLAN) service providing unit to turn on a WLAN function to search an accessible access point if an entry into a WLAN service area is recognized through a RAT specific channel in the wake mode, is the RAT specific channel being at least one of the RAT channels.

An exemplary embodiment provides a method for network access of an FMC apparatus, the method including: performing, by the FMC apparatus, a discontinuous reception (DRX) operation to periodically enter into a wake mode; monitoring, by the FMC apparatus, radio access technology (RAT) channels in the wake mode; and turning on, by the FMC apparatus, a wireless local area network (WLAN) function to search an accessible access point if an entry into a WLAN service area is recognized through a RAT specific channel in the wake mode, the RAT specific channel being at least one of the RAT channels.

An exemplary embodiment provides a method for network access of an FMC apparatus, the method including: performing a discontinuous reception (DRX) operation to periodically alternate between a sleep mode and a wake mode; monitoring radio access technology (RAT) channels in the wake mode; determining if a received signal strength indicator (RSSI) value of a signal received through the RAT channels is greater than a threshold; turning on a wireless local area network (WLAN) function to search an accessible access point if the RSSI is determined to be greater than the threshold; scanning for accessible access points; and connecting to an accessible access point if an access point is found as a result of the scanning, and turning off the WLAN function if no access point is found as a result of the scanning.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic view of a system including a fixed mobile convergence (FMC) apparatus according to an exemplary embodiment.

FIG. 2 is a reference view illustrating the basic operation of the FMC apparatus shown in FIG. 1.

FIG. 3 is a configuration view of cells illustrating the operation in movement of the FMC apparatus shown in FIG. 1.

FIG. 4 is a timing diagram illustrating the power saving mechanism of the FMC apparatus shown in FIG. 1.

FIG. 5 is a flowchart illustrating a method for searching the FMC apparatus according to an exemplary embodiment.

### DETAILED DESCRIPTION OF THE ILLUSTRATED EMBODIMENTS

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

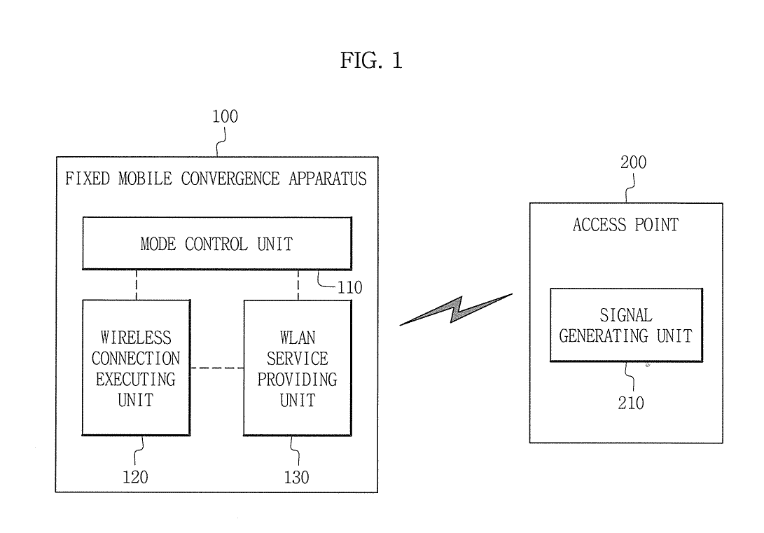

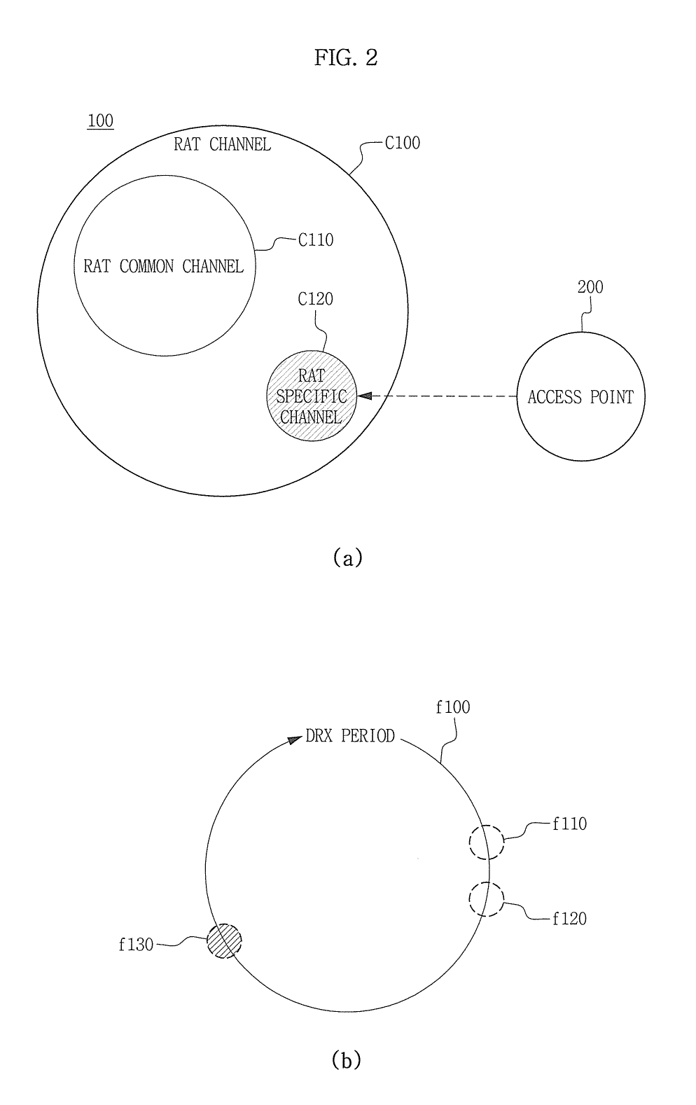

FIG. 1 is a schematic view of a system including a fixed mobile convergence (FMC) apparatus according to an exemplary embodiment. FIG. 2 is a reference view illustrating is the basic operation of the FMC apparatus shown in FIG. 1.

The FMC apparatus 100 is includes a wireless local area network (WLAN) and a mobile communication terminal provided with radio access technology (RAT). The FMC apparatus 100 searches a WLAN service area including an access point 200 through a RAT specific frequency generated from the access point 200, thereby obtaining a suitable plan.

In a case in which the FMC apparatus 100 attempts a connection to the access point 200 to use a WLAN service in a specific area including a WLAN, the FMC apparatus 100 allows an on/off state of the WLAN to be automatically controlled through an idle RAT specific frequency in the frequency band of the RAT. In a case in which the FMC apparatus 100 is moved to an area in which a WLAN service is not provided, the FMC apparatus 100 maintains the WLAN function in an off state so as to prevent the occurrence of unnecessary power consumption, and turns on the WLAN function for scanning an access point list if the WLAN service area is recognized through the RAT specific frequency. According to some aspects, the WLAN function may be turned on only if the WLAN service area is recognized through the RAT specific frequency.

The FMC apparatus 100 includes a RAT, such as WCDMA, GSM, or LTE, and monitors the frequency band of the provided RAT at all times. Thus, if a signal in an idle frequency band of the RAT frequency band is generated through the access point 200, the FMC apparatus 100 receives the generated signal, thereby recognizing the existence of the access point 200. In a case in which the FMC apparatus 100 enters into the WLAN service area including the access point 200, the FMC apparatus 100 checks a portion of the RAT frequency band always monitored, thereby obtaining corresponding information. Also, the FMC apparatus can sense the existence of the access point 200 by normally monitoring a reception (RX) channel for the RAT, is without performing a separate operation to recognize the WLAN service area. Accordingly, power can be saved through such a method.

Referring to FIG. 1, the FMC apparatus 100 includes a mode control unit 110 to perform a discontinuous reception (DRX) operation, a wireless connection executing unit to search RAT channels, and a WLAN service providing unit 130 to provide a WLAN service.

The mode control unit 110 periodically repeats a sleep mode and a wake mode so as to perform the DRX operation.

Since a mobile communication terminal that implements the RAT is wireless, power saving mechanisms are used. One of the mechanisms is a DRX operation. The DRX operation is a method to reduce unnecessary power consumption in communications with a network. For example, a terminal in an idle state responds to a paging signal from the network. The simplest method for responding the paging signal is continuous RX. In continuous RX, the terminal opens the RX channel and continuously checks the presence of the paging signal from the network.

On the other hand, if the DRX is used, the terminal opens the RX channel at a specific instance to check the presence of the paging signal. Thus, power management may be more efficient.

The terminal performs the DRX operation by periodically repeating the sleep mode, which is a power saving mode, and the wake mode during its idle state. For example, in a case in which the WCDMA in the RAT is provided to the terminal, the terminal checks the presence of the paging signal through a paging indication channel (PICH) in the wake mode. If no paging signal exists, the terminal returns back to the sleep mode. The PICH is a channel for searching the paging signal in the RX channel. In order to save the power of a battery, the is terminal can turn off the power to circuits in the sleep mode but need not turn off power to all circuits.

As the FMC apparatus 100 is converted from the sleep mode to the wake mode, the wireless connection executing unit 120 executes monitoring of the RAT channels. For example, in a case in which the WCDMA in the RAT is provided to the FMC apparatus 100, the RAT channels are RX channels of the WCDMA.

Referring to FIG. 2(a), RAT channels C100 monitored by the wireless connection executing unit 120 in the wake mode include RAT common channels C110 for RAT services and RAT specific channels C120 for WLAN services.

The RAT specific channels C120 refer to some channels assigned for the WLAN services in remaining channels except the RAT common channels C110. The RAT specific channels C120 belong to a portion of the idle frequency band which is not used by the RAT common channels C110 in the RAT frequency band monitored by the FMC apparatus 100 s through the RAT channels. That is, the FMC apparatus 100 searches a WLAN signal in the RAT specific frequency band through the RAT specific channels C120, and the access point 200 generates a corresponding signal to inform the FMC apparatus 100 of the entry into the WLAN service area.

For example, RX channels from 10562 to 10838 exist in the WCDMA. Among these RX channels, channels used within the country are four in ‘SKT’, i.e., 10664, 10689, 10713, and 10737, and four in ‘KT’, i.e., 10812, 10836, 10787, and 10763. The signal generating unit 210 generates a signal for a fixed specific channel in idle channels not used as common channels in the WCDMA. The terminal for implementing the WCDMA has an ability of searching all the frequencies of 10562 to 10838. Thus, the search of the access point 200 is supported by using some of the idle channels not used as common channels in the WCDMA so that the WLAN function can be easily added to the terminal provided with the WCDMA. Also, the WLAN services and the automatic search of the access point 200 can be supported without changing hardware.

In the case of the WCDMA, RX channels of 10562 to 10838 become the RAT channels C100. In a case in which four channels among the RX channels, i.e., 10664, 10689, 10713, and 10737, are implemented as the RAT common channels C110, one (e.g., 10770) of the other channels except the four channels may be used as the RAT specific channel C120.

If the sleep mode is converted in the wake mode by the mode control unit 120, the wireless connection executing unit 120 monitors the RAT channels. Specifically, the wireless connection executing unit 120 monitors the RAT common channels so as to provide RAT services, such as cell search, in the wake mode. In addition, the wireless connection executing unit 120 checks the RAT specific channel defined to receive the WLAN signal in the RAT specific frequency band, generated from the access point 200, thereby identifying whether the FMC apparatus 100 enters into the WLAN service area.

The search of the RAT specific channel may be automatically performed together with the search of the RAT common channels, or may be selectively performed according to a user input or design condition. For example, in a case in which the entry into the WLAN service area is recognized through the RAT specific channel, the WLAN service providing unit 130 may display a message to inform of the entry into the WLAN service area and to inquire of the on/off state of the WLAN function, and then determine whether the WLAN function is turned on based on the user's input.

Alternatively, if the sleep mode is converted into the wake mode, the wireless connection executing unit 120 may first check the RAT common channels to identify whether a paging signal is received. In a case in which the paging signal is not received, the wireless connection executing unit 120 may check the RAT specific channel to identify the presence of the WLAN service area.

In the wake mode, if the search of the RAT channels is completed and the access point 200 is recognized through the RAT specific channel in the channel search process, the WLAN service providing unit 130 searches accessible access points, e.g., access point 200, by turning on the WLAN function.

In the wake mode, the wireless connection executing unit 120 opens the RAT channels, particularly, the RAT specific channel C120 for searching the access point 200, to measure the intensity of a signal received through the corresponding channel, and recognizes that the FMC apparatus 100 enters into the WLAN service area when the measured intensity of the signal exceeds a threshold, thereby informing the WLAN service providing unit 130 of corresponding information. In this case, the WLAN service providing unit 130 turns on the WLAN function and then searches accessible access points 200 in the state that the WLAN is turned on. Specifically, the WLAN service providing unit 130 scans an access point list in the state that the WLAN function is turned on, and attempts a connection to an adjacent access point 200 based on the scanning result. In a case in which the adjacent access point 200 is not searched as the scanning result, the WLAN service providing unit 130 turns off the WLAN function.

Referring back to FIG. 1, the access point 200 includes a signal generating unit 210 to generate a WLAN signal in the RAT specific frequency band. Thus, the access point 200 enables the FMC apparatus 100 to receive the corresponding signal through the RAT specific channel and to recognize the entry into the WLAN service area.

The signal generated by the signal generating unit 210 uses an idle frequency band in the RAT frequency band monitored by the FMC apparatus 100. For example, in a case in which the FMC apparatus 100 is provided with the WCDMA, a portion of the idle frequency band in which the RAT common channels are not used in the frequency band of the WCDMA may be used for signal search of the access point 200. For the RAT specific channel of the FMC apparatus 100, the signal generating unit 210 of the access point 200 generates a WLAN signal in the RAT specific frequency band to be more than a determined received signal strength indication (RSSI).

FIG. 2(b) illustrates a process in which the FMC apparatus 100 searches a RAT frequency band based on a DRX period. In the RAT frequency band f100, a first frequency band f110 is a WCDMA frequency band, a second frequency band f120 is an LTE frequency band, and a third frequency band f130 is a RAT specific frequency band used by the access point 200.

For example, in a case in which the FMC apparatus 100 is provided with the WCDMA, the FMC apparatus 100 searches the first frequency band f110 through the RAT common channels during the DRX period and then searches the third frequency band f130 through the RAT specific channel, thereby identifying the existence of the access point 200. In a case in which the FMC apparatus 100 is provided with the LTE, the FMC apparatus 100 searches the second frequency band f120 through the RAT common channels and then searches the third frequency band f130 through the RAT specific channel.

As described above, in order to use the WLAN services, the FMC apparatus 100 automatically searches the access point 200 using an idle frequency band of the RAT service, and performs a search operation for the access point 200 in an area available for the WLAN services, thereby decreasing power consumption unnecessary in providing the RAT and WLAN services. According to aspects, the search operation may be performed only in an area available for the WLAN services.

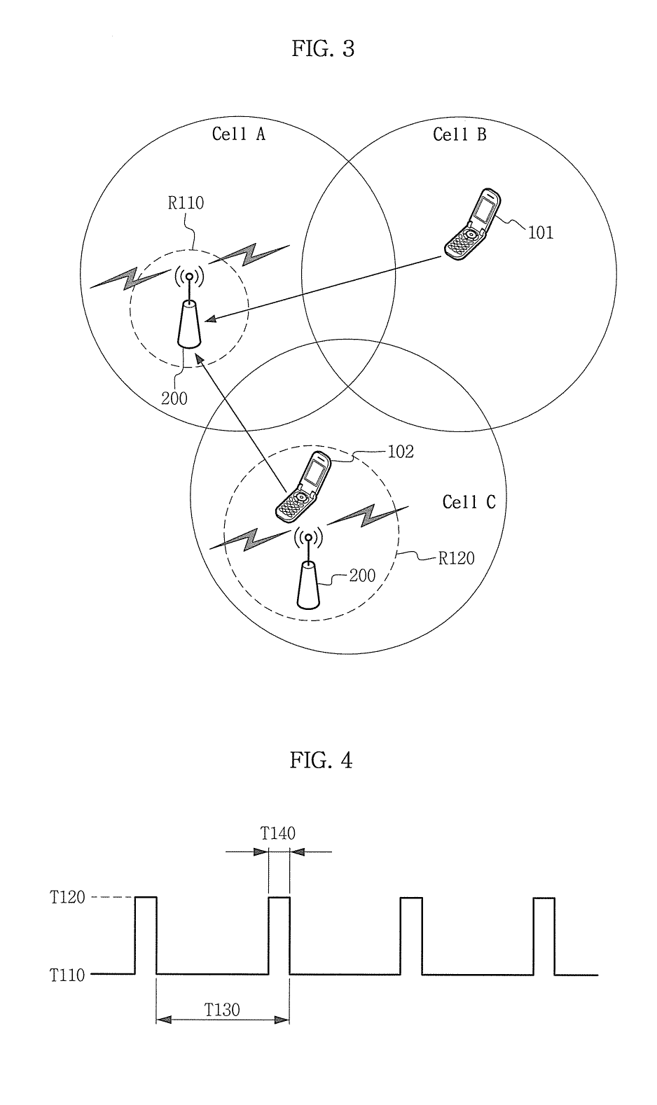

FIG. 3 is a configuration view of cells illustrating the operation in movement of the FMC apparatus shown in FIG. 1, which illustrates that power can be saved through the effective search of the access point 200 and the on/off state of the WLAN function.

When the FMC apparatus 100 is moved to an area in which the WLAN services are provided and an area in which the WLAN service is not provided, it automatically turns on/off the WLAN function.

In FIG. 3, in a case in which a first FMC apparatus 101 is moved from cell B, in which the WLAN services are not provided, to cell A, in which the WLAN service is provided, the first FMC apparatus 101 periodically attempts a search of the RAT specific channel for the WLAN service based on the DRX period as shown in FIG. 2. In a case in which a RAT specific frequency signal is searched in the corresponding channel, the first FMC apparatus 101 turns on the WLAN function to receive the WLAN service.

In a case in which a second FMC apparatus 102 is moved to a WLAN service area R110 in the cell A while receiving the WLAN service in a WLAN service area R120 in cell C, the second FMC apparatus 102 turns off the WLAN function in an area in which the RAT specific frequency signal for informing the existence of the access point 200 during the movement, thereby saving power. In a case in which the second FMC apparatus 102 reaches the WLAN service area R110 in the cell A, the second FMC apparatus 102 attempts a search of the RAT specific channel based on the DRX period as shown in FIG. 2 so that the WLAN function can be automatically turned on.

FIG. 4 is a timing diagram illustrating the power saving mechanism of the FMC apparatus shown in FIG. 1. The FMC apparatus 100 repeats a wake operation and a sleep operation, and searches specified channels of the RAT periodically (in the wake operation) so as to receive the RAT and WLAN services. During one DRX period T130, the FMC apparatus 100 is converted from a sleep mode T110 to a wake mode T120 so as to identify RAT channels (RAT common channels for the RAT service and a RAT specific channel for the WLAN service) during a wake period T140. In a case in which no signal received in the corresponding channel exists during the wake period T140, the FMC apparatus 100 returns back to the sleep mode T110 to save power. The wake period T140 may be at an end of the DRX period T130, as shown in FIG. 4; however, aspects are not limited thereto such that the wake period T140 may be at the beginning of the DRX period T130 or elsewhere within the DRX period T130. Further, although the wake period T140 is shown at being at a same place within each of the DRX period T130, aspects are not limited thereto such that the wake period T140 may be in other places within the DRX period T130, for example, the wake period T140 may be randomly located within the DRX period T130.

As described above, the FMC apparatus 100 performs a search for the RAT channels during the DRX period T130. Since the wake period for searching the RAT common channels is very short, the period for simultaneously searching the RAT common channels and the RAT specific channel may be an arbitrary period longer than the wake period.

Table 1 illustrates a DRX period T₁ of a terminal provided with the WCDMA in the RAT. As shown in Table 1, the DRX period T130 may be defined as 2ⁿ*10 msec, of which n may the set value set within a range, i.e., n=7, resulting in a DRX period T130 of 1.28 seconds.

TABLE 1

| | Range | Set value n | |
|---|---|---|---|
| Parameter | of n | (period length) | Definition |
| CN_DRXCYCLE | 6~9 | 7 (1.28 sec) | DRX period = 2ⁿ * 10 |
| | | | msec |

In a case in which the FMC apparatus 100 has a type of a WCDMA terminal provided with a WCDMA function, a DRX period T₂ for performing all searches up to the RAT specific channel may be a positive number times the DRX period T₁ in the WCDMA terminal, i.e., T₁*N (N is a positive number, N≧1).

The FMC apparatus 100 performs monitoring of the RAT channels during the wake period T140, and particularly, performs a search of the RAT specific channel so as to identify whether the RAT specific frequency signal for the WLAN service exists. In a case in which the reception level of the searched RAT specific channel is more than a threshold, the FMC apparatus 100 senses the existence of the access point 200 for WLAN service, and automatically turns on the WLAN function to receive the corresponding service.

Here, channels monitored for the RAT service in the RAT channels implemented in the FMC apparatus 100 become the RAT common channels, and a separately specified idle channel distinguished from the RAT common channels becomes the RAT specific channel. For example, in a case in which the FMC apparatus 100 is provided with the WCDMA in the RAT, it may use channels 10664, 10689, 10713, and 10737 as the RAT common channels, and may use 10770 as the RAT specific channel.

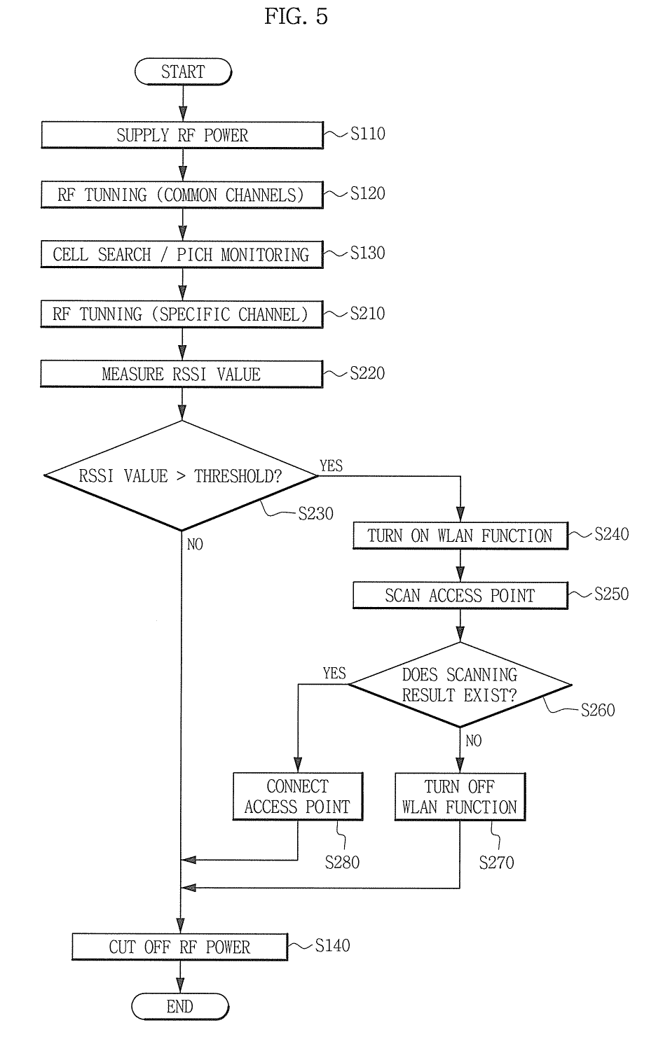

FIG. 5 is a flowchart illustrating a method for searching the FMC apparatus according to an exemplary embodiment. For convenience of illustration, it is assumed that the FMC apparatus 100 is provided with the WCDMA in the RAT so as to provide WCDMA services through the wireless connection executing unit 120. The FMC apparatus 100 periodically enters by performing DRX operations while repeating sleep and wake modes.

In the wake mode, the FMC apparatus 100 monitors RAT channels, and particularly, detects a WLAN signal in a RAT specific frequency band during a DRX period so as to search a RAT specific channel. In the wake mode, if the FMC apparatus recognizes the entry into a WLAN service area through the RAT specific channel, which is a portion of the RAT channels, the FMC apparatus turns on a WLAN function to search an accessible access point 200.

Referring to FIG. 5, in operation S110, at the time when the FMC apparatus 100 is converted from the sleep mode from the wake mode, power is supplied to the wireless connection executing unit 120. The wireless connection executing unit 120 primarily performs radio frequency (RF) tuning to search RAT common channels assigned for the RAT service in the RAT channels in operation S120.

In the RF tuning process for the RAT service in operation S120, the wireless connection executing unit 120 performs a cell search and identifies whether a paging signal through monitoring of a PICH is received. In a case in which the paging signal exists in operation S130, the wireless connection executing unit 120 performs subsequent processes, thereby providing the RAT service.

Thereafter, the FMC apparatus 100 secondarily performs RF tuning with respect to a RAT specific channel that receives a WLAN signal in the RAT specific frequency band generated from the signal generating unit 210 of the access point 200 in operation S210. The wireless connection executing unit 120 monitors the RAT specific channel to check whether the WLAN signal in the RAT specific frequency band is received, generated from the external access point 200. The RAT specific channel may be a channel defined to search a RAT specific frequency signal among the idle channels except the RAT common channels in the RAT channels.

Thereafter, the wireless connection executing unit 120 measures the intensity of the signal received through the RAT specific channel in operation S220. In a case in which the intensity of the signal measured through the RAT specific channel exceeds a threshold in operation S230, the wireless connection executing unit 120 recognizes the entry into a WLAN service area in which the access point 200 exists, and accordingly, the WLAN service providing unit 130 automatically turns on the WLAN function and then controls accessible access points 200 to be searched in operations S240 and S250.

That is, in a case in which the RSSI value of the signal received through the RAT specific channel, generated from the signal generating unit 210, exceeds the threshold in operation S230, the FMC apparatus 100 turns on the WLAN function for scanning an access point list in operation S240, and scans the access point list for neighboring access points 200 in operation S250. In a case in which the access point list for accessible access points is scanned using the WLAN function and a searched result exists in operation S260, the FMC apparatus 100 attempts a connection to the searched access point 200 in operation S280. If no searched result exists, the FMC apparatus 100 turns off the WLAN function to cut off the power of the WLAN service providing unit 130 in operation S270, and returns back to the sleep mode to cut off the power of the wireless connection executing unit 120 in operation S140.

The search of the RAT specific channel in operation S210 and the turn-on operation of the WLAN function in operation S240 may be performed in other manners in addition to automatic performance.

For example, the FMC apparatus 100 identifies whether the paging signal is received by checking the RAT common channels assigned for the RAT service in the RAT channels. In a case in which it is identified that no paging signal is received, the FMC apparatus 100 may check the RAT specific channel.

In the case of a WCDMA terminal, a paging slot is assigned to check a paging message on S-CCPCH, which is a paging channel. Then, the WCDMA terminal searches an indicator for informing that the paging message is being transmitted by decoding a PICH. If no indicator is searched, the WCDMA terminal does not read the assigned paging slot but returns back to a sleep mode. In a case in which no paging indicator is searched, the FMC apparatus 100 does not return back to the sleep mode but searches the RAT specific channel to identify the presence of the WLAN service area in which the access point 200 exists.

In a case in which the intensity of the signal measured through the RAT specific channel exceeds the threshold, the FMC apparatus 100 recognizes the entry into the WLAN service area. Thus, the FMC apparatus 100 may display a message to inform of the entry into the WLAN service area and to inquire of the on/off state of the WLAN function and then determine whether the WLAN function is turned on based on the user's input.

The method for automatically searching the access point 200 is provided through the aforementioned configuration so that it is possible to provide users with convenience in which they use services in the presence of the services. Also, the FMC apparatus 100 searches the access point 200 in an area available for the WLAN service so that it is possible to reduce unnecessary power consumption. According to aspects, the FMC apparatus 100 may search only in an area available for the WLAN service.

As described above, according to exemplary embodiments, an access point is effectively searched using a frequency searching method of the RAT service, and power consumption for the WLAN service, thereby enhancing the efficiency of power consumption.

Also, the FMC apparatus recognizes an area available for the WLAN service and automatically searches an access point in the corresponding area, so that it is possible to provide convenience in which a user uses the services in the presence of the service.

While the disclosure has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A fixed mobile convergence (FMC) apparatus, comprising:
a control unit to periodically alternate between a sleep mode and a wake mode to perform a discontinuous reception (DRX) operation;
a wireless connection executing unit to monitor radio access technology (RAT) channels in the wake mode; and
a wireless local area network (WLAN) service providing unit to turn on a WLAN function to search an accessible access point if an entry into a WLAN service area is recognized through a RAT specific channel in the wake mode, the RAT specific channel being at least one of the RAT channels.

2. The FMC apparatus of claim 1, wherein the RAT specific channel is at least one of idle channels except RAT common channels of the RAT channels, and a WLAN signal in a RAT specific frequency band, generated from the access point, is searched through the RAT specific channel.

3. The FMC apparatus of claim 1, wherein the WLAN service providing unit automatically turns on the WLAN function if the entry into the WLAN service area is recognized through the RAT specific channel.

4. The FMC apparatus of claim 1, wherein, if the entry into the WLAN service area is recognized through the RAT specific channel, the WLAN service providing unit displays a message to inform of the entry into the WLAN service area and to inquire of an on/off state of the WLAN function, and determines whether the WLAN function is turned on based on a user's input.

5. The FMC apparatus of claim 1, wherein the WLAN service providing unit scans the access point in an on state of the WLAN function to attempt a connection to the access point based on the scanning result, and turns off the WLAN function if the access point is not found based on the scanning result.

6. The FMC apparatus of claim 1, wherein the wireless connection executing unit measures the intensity of a signal received through the RAT specific channel in the wake mode, and recognizes the entry into the WLAN service area to inform the WLAN service providing unit if the measured intensity of the signal exceeds a threshold.

7. The FMC apparatus of claim 1, wherein the wireless connection executing unit checks the RAT common channels of the RAT channels to identify whether a paging signal is received if the sleep mode is converted into the wake mode, and checks the RAT specific channel to recognize the presence of the entry into the WLAN service area if no paging signal is received.

8. A method for network access of a fixed mobile convergence (FMC) apparatus, the method comprising:
performing, by the FMC apparatus, a discontinuous reception (DRX) operation to periodically enter into a wake mode;
monitoring, by the FMC apparatus, radio access technology (RAT) channels in the wake mode; and
turning on, by the FMC apparatus, a wireless local area network (WLAN) function to search an accessible access point if an entry into a WLAN service area is recognized through a RAT specific channel in the wake mode, the RAT specific channel being at least one of the RAT channels.

9. The method of claim 8, wherein the monitoring of the RAT channels comprises:
monitoring RAT common channels in the RAT channels to perform a cell search; and
monitoring the RAT specific channel in the RAT channels to check whether a WLAN signal is received in a RAT specific frequency band, the WLAN being generated from the access point.

10. The method of claim 8, wherein, in the turning on of the WLAN function, the FMC apparatus recognizes the entry into the WLAN service area and automatically turns on the WLAN function if the intensity of a signal, measured through the RAT specific channel, exceeds a threshold.

11. The method of claim 8, wherein, in the turning on of the WLAN function, the FMC apparatus displays a message for informing of the entry into the WLAN service area and inquiring of the on/off state of the WLAN function, and determines whether the WLAN function is turned on based on an user's input, if the intensity of a signal, measured through the RAT specific channel, exceeds a threshold.

12. The method of claim 8, wherein, in the monitoring of the RAT channels, the FMC apparatus checks the RAT common channels in the RAT channels to identify whether a paging signal is received, and checks the RAT specific channel if no paging signal is received as the identified result.

13. The method of claim 8, wherein the turning on of the WLAN function comprises:
turning on the WLAN function for scanning the access point if the intensity of the signal, measured through the RAT specific channel, exceeds a threshold;
scanning the access point to attempt a connection to the access point based on the scanning result; and
turning off the WLAN function if no access point is found as the scanning result.

14. A method for network access of a fixed mobile convergence (FMC) apparatus, the method comprising:
performing a discontinuous reception (DRX) operation to periodically alternate between a sleep mode and a wake mode;
monitoring radio access technology (RAT) channels in the wake mode;
determining if a received signal strength indicator (RSSI) value of a signal received through the RAT channels is greater than a threshold;
turning on a wireless local area network (WLAN) function to search an accessible access point if the RSSI is determined to be greater than the threshold;
scanning for accessible access points; and
connecting to an accessible access point if an access point is found as a result of the scanning, and turning off the WLAN function if no access point is found as a result of the scanning.

15. The method of claim 14, wherein the performing the discontinuous reception (DRX) operation comprises:
supplying power to perform radio frequency (RF) tuning to search RAT common channels of the RAT channels.

16. The method of claim 14, wherein the performing the discontinuous reception (DRX) operation comprises:
performing a cell search and identifying whether a paging signal is received through monitoring of a paging indication channel (PICH).

17. The method of claim 16, further comprising:
performing RF tuning with respect to a RAT specific channel to receive a WLAN signal from an accessible access point.

18. The method of claim 17, wherein:
the signal received through the RAT channels for which the RSSI value is determined is the WLAN signal received through the RAT specific channel.
